(19) United States
(12) Patent Application Publication
(10) Pub. No.: US 2010/0120349 A1
(43) Pub. Date: May 13, 2010

(54) Surgical theater ventilating devices and methods

(75) Inventors: Dan Kristensson, Angelholm (SE); Jan Kristensson, (US); Pål Martin Svensson, Halmstad (SE)

Correspondence Address: STITES & HARBISON PLLC, 1199 NORTH FAIRFAX STREET, SUITE 900, ALEXANDRIA, VA, 22314, US

(73) Assignee: AIRSONETT AB, Angelholm (SE)

(21) Appl. No.: 12/610,279

(22) Filed: Oct. 31, 2009

Related U.S. Application Data
(60) Provisional application No. 61/110,068, filed on Oct. 31, 2008.

(51) Int. Cl. B01L 1/04; F24F 13/08

(52) U.S. Cl. 454/187; 454/258

(57) ABSTRACT

Provided are methods for ventilating a surgical theater using temperature-regulated laminar air flow. Velocity of a downward directed laminar clean air flow is determined by an air-temperature difference between the supply air and room air temperature at the level of the operating table. Room air temperature at the level of the operating table is measured and clean supply air temperature controlled in relation to this measurement. In order to maintain a constant downward directed laminar clean air flow velocity, a constant difference in temperature is maintained between room air temperature at the level of the operating table and the lower temperature of the supply air. In preferred embodiments, this constant temperature difference provides a downward directed air flow velocity of at least 0.25 m/s and is maintained in part by minimizing fluctuations in ambient air-temperature through use of air supply units supplying heated or cooled air outside the clean air zone. Also provided are ventilating devices which create a uniform and stable downward laminar air flow that forms a clean air zone surrounding the operating table workplace region. Preferred embodiments comprise a number of air supply units arranged in a closed pattern, e.g, in a circle, with air stop and guide units situated between air supply units such that a widely spread uniform and stable, downward, combined, laminar air flow is created.

This application claims priority to U.S. Provisional 61/110,068 filed Oct. 31, 2008.

### FIELD OF THE INVENTION

The present invention relates in general to devices and methods for providing a zone of clean air in the operating table workplace region of a surgical theater, and in particular, to methods and devices that utilize temperature controlled laminar air flow.

### BACKGROUND

Surgical site infections (SSIs) are the second most common cause of hospital acquired infections. 1.5% to 20% of surgical operations leads to a Surgical Site Infection (SSI), depending on the type of surgical procedure and the wound classification.

Patients who develop SSIs suffer significant debilitation and increased risk. Patients with SSIs have up to 60% increased likelihood of hospitalization in an intensive care unit. Patients with SSIs have 5 times greater likelihood of readmission to the hospital and 2 times greater risk of death than patients without SSIs.

Societal costs for SSI's are substantial. European studies shows that the average extended length of stay for an infected patient is 9.8 days. The cost per SSI patient is between [symbol] 1,862 to [symbol] 4,047 in direct costs in hospital costs alone. From 30 million surgical procedures a year the resulting numbers of SSIs amounts to 0.45 to 6 million, giving rise to a total SSI cost in Europe of somewhere between [symbol] 1.47 to [symbol] 19.1 billion/year. Studies from USA show similar figures with an average extended length of stay for an infected patient of somewhere between 7 to 10 days. The cost per SSI patient between $8,200 to $42,000 including indirect costs. With approximately 0.5 million SSI cases per year, total SSI cost in the USA is in the range between $1 to $10 billion/year.

The primary contributing cause to development of surgical site infection (SSI) is generally acknowledged to be bacterial contamination of the operating room air either directly contaminating the patient's wound or indirectly contaminating sterile surgical equipment.

It is also generally accepted that the origin of this bacterial contamination of operating room air is predominantly contaminated skin scales shed from surgical team members.

Pre operative actions have proved effective in reducing risk of SSIs, including: Antimicrobial prophylaxis, preparation of the patient, hand/forearm antisepsis for surgical team members, and management of infected or colonized surgical personnel. Postoperative incision care and postoperative surveillance have also proved effective in reducing risk of SSIs.

Other promising measures for preventing SSIs focus on activities in the operating theater, during the course of the operation. Cleaning and disinfection of environmental surfaces, microbiologic sampling, sterilization of surgical instruments, surgical attire and drapes, and improved asepsis and surgical techniques have all been reported. Of particular interest, improved clean air ventilation in the operating theater has been shown to reduce risk of SSIs. Charnley et al. reports that vertical laminar airflow systems and exhaust-ventilated clothing can decrease the risk of attaining a SSI from 9% to 1%. Lidwell et al. has, comparing the effects of laminar airflow systems and anti-microbial prophylaxis in a study of 8,000 total hip and knee replacements, measured a decrease in SSI rate from 3.4% to 1.6% simply from use of laminar airflow systems. It is now generally understood that vertical Laminar Air Flow (LAF) systems in surgical theaters provide the most effective techniques for reducing the numbers of bacteria-carrying particles within the operative area.

However, some problems with vertical laminar air flow systems yet remain. The main source/s of bacteria-carrying particles (skin flakes) are the personnel within the surgical theatre. The most physically active operative personnel operate within the actual boundaries of the laminar air flow.

Skin flakes shed from operative personnel/human bodies must be prevented from reaching the patient's exposed wound. In order to accomplish this, the descending laminar air flow should brake, and immediately bring downwards, lighter/warm convection air flow generated from the warm human bodies of operative personnel and carrying potentially infectious skin flakes. These particles can then be evacuated at floor level.

In order to be effective in braking human body convection flows, the velocity of the downward directed laminar air flow needs to be at least about 0.25 m/s as measured at the levels of the patient's exposed wound. This downward velocity needs to be maintained constant during the entire operation. Higher velocities above about 0.25 m/s cause familiar problems of draft and dehydration for operative personnel and, further, give rise to turbulent air flows which compromise the advantages of a laminar flow system.

The velocity of a free-flowing vertical laminar air stream with a limited cross section is either enforced or repressed depending on the temperature difference between the flowing air and the ambient still-standing volume of air. Cold air has a higher density than warmer air and vice versa. A free-flowing vertical laminar air stream which is relatively colder than the ambient air volume will descend/fall as long as this difference in density (temperature) is maintained. In order to establish a downward directed (vertical) laminar air stream flowing (falling) through an air volume with an equal or lower temperature, a set up is required with aligned supply- and exhaust air devices having relatively tight distances between. In surgical theatres, this becomes expensive, space demanding and limiting for surgical procedures and for operative personnel.

More advanced LAF systems cool and control the supply air temperature by keeping it constant to a set temperature, which can be adjusted according to the demands of the operative personnel and type of surgical procedure. However, these systems are intended to control the temperature for the operative personnel working beneath the ceiling mounted LAF air delivery devices. They do not adjust the supply air temperature according to varying temperature within the theatre. In actual practice, room temperature fluctuations can occur due to varying heat loads including heat from operative personnel, surgical lights, other electric equipment, surrounding surfaces and in some cases sunlight. Further, these LAF devices of the prior art utilize forced blowing as the driving force for controlling the downward directed air velocity. This forced blowing generally entails a high initial air velocity of at least double the desired velocity at the operating table. This in turn results in disturbing effects, e.g. turbulence, arising from, for example, operating lighting or other equipment situated between the ventilating device and the workplace region. This turbulence is associated with in-mixing of contaminated ambient air into the clean air flow. The high air velocity also creates strong secondary air flows outside the workplace region which keep bacteria-bearing and other particles suspended, increasing the risk of contamination of the workplace region. High air flow velocity also subjects personnel to draughts and high noise levels. Further, room temperature fluctuations may result in fluctuations of the actual downward directed velocity during and between surgery.

The problems associated with forced-blowing systems can be avoided through use of temperature-controlled laminar air flow. The principle of temperature controlled laminar air flow (TLA) is that a laminar flow is induced by an air-temperature difference between supply air and ambient air at the level of the operating table. A laminar flow of filtered, colder air, having a higher density than ambient air descends slowly, enveloping the operating table workplace region. Because the supply air flow is substantially laminar, and in-mixing with ambient air is minimized, the air-temperature difference is maintained throughout the path of descent. Only minimal impulse is imparted to the supply air stream, sufficient to overcome resistance at the outlet nozzle.

Here we describe improved air supply devices as well as methods for temperature-regulated laminar air flow ventilation, providing a zone of clean air in the operating table workplace region of a surgical theater.

### SUMMARY

Some embodiments of the invention provide methods for ventilating a surgical theater using temperature-regulated laminar air flow. Velocity of a downward directed laminar clean air flow is determined by an air-temperature difference between the supply air and room air temperature at the level of the operating table. Room air temperature at the level of the operating table is measured and clean supply air temperature controlled in relation to this measurement. In order to maintain a constant downward directed laminar clean air flow velocity, a constant difference in temperature is maintained between room air temperature at the level of the operating table and the lower temperature of the supply air. In preferred embodiments, this constant temperature difference provides a downward directed air flow velocity of at least 0.25 m/s and is maintained in part by minimizing fluctuations in ambient air-temperature through use of air supply units supplying heated or cooled air outside the clean air zone. Also provided are ventilating devices which create a uniform and stable downward laminar air flow that forms a clean air zone surrounding the operating table workplace region. Preferred embodiments comprise a number of air supply units arranged in a closed pattern, e.g, in a circle, with air stop and guide units situated between air supply units such that a widely spread uniform and stable, downward, combined, laminar air flow is created.

### BRIEF DESCRIPTION OF THE DRAWINGS

FIG. 1 is a schematic side view of a ventilating device according to the invention and the air flows generated by it.

FIG. 2 is a somewhat enlarged side view of a container with air supply units, and with air stop and guide units disposed between the air supply units, for the ventilating device shown in FIG. 1.

FIG. 3 is a cross-sectional plan view of the container with the air supply units and the air stop and guide units according to FIG. 2.

FIG. 4 is an enlarged side view of part of FIG. 2.

### DETAILED DESCRIPTION OF PREFERRED EMBODIMENTS

In some embodiments, the invention provides a method for ventilating a surgical theater comprising
Discharging a purified air stream through an air supply device, situated above the operating table workplace area, as a substantially laminar descending air flow with velocity determined by the difference in air-temperature between the supplied air and the ambient air at the level of the operating table
   wherein a constant difference in air-temperature between the supplied air and the ambient air at the level of the operating table is maintained in part by use of air supply units providing heated or cooled supply air outside the operative area in order to minimize fluctuations in ambient air-temperature.

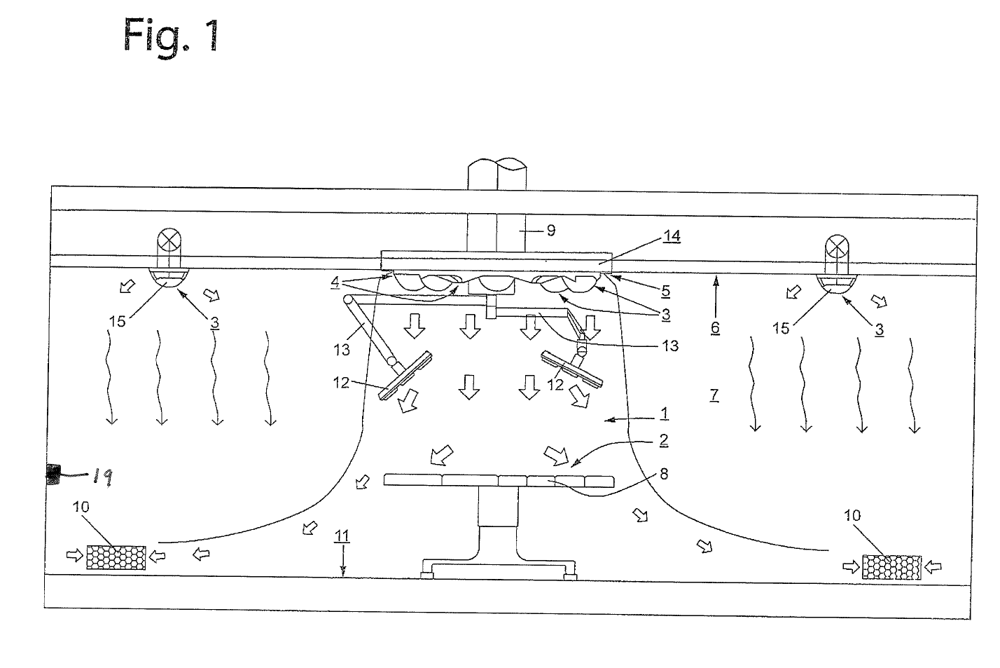

FIG. 1 shows one preferred embodiment of a ventilating device suitable for practice of methods of the invention. The device shown in FIG. 1 is intended to create a zone 1 of clean air between the ventilating device and a workplace region, here the operating region 2 in a surgical theater. The ventilating device comprises air supply units 3 which may be of a conventional type and are adapted to generating laminar air flows intended to constitute said clean air zone 1.

It is advantageous to achieve a total air flow with a large spread which therefore serves a large region within which personnel have freedom of movement for their work. In some preferred embodiments, the ventilating device according to the invention comprises at least three air supply units 3 disposed in a closed trilateral pattern of three air supply units. The result is that the clean air zone 1 has below the air supply units 3 an extent which in cross-section substantially corresponds to the surface delineated by said closed pattern of air supply units and the surface situated within that pattern, i.e. substantially the extent indicated by FIG. 1. In other embodiment, a single large air supply unit may be used, for example, a large ring-shaped unit.

To prevent or hinder air surrounding the clean air zone 1 and containing bacteria bearing and other pollutant particles from being drawn in between the air supply units and into the clean air zone by the negative pressure and consequent suction force generated in the clean air zone by the air flows of the mutually adjacent air supply units 3, some preferred embodiments comprise in addition a corresponding number of, i.e. at least three, air stop and guide units 4 disposed between the respective pairs of mutually adjacent air supply units.

As well as being trilateral or circular as indicated above, the closed pattern of air supply units 3 may also be, for example, elliptical, square, rectangular or have five, six or more sides or a combination of different shapes. In such cases, the air stop and guide units are suitably disposed in corresponding patterns in the spaces delineated between mutually adjacent air supply units 3. Each air stop and guide unit 4 will with advantage also fill the whole space between two mutually adjacent air supply units 3.

The number of air supply units 3 and the number of air stop and guide units 4 disposed between them each amount preferably to between 3 and 15, depending on the desired extent of the region to be served by the ventilating device. In the preferred version depicted in the drawings, the number of air supply units 3 and air stop and guide units 4 is eight (8) each.

The air supply units 3 and the air stop and guide units 4 disposed between them in the version depicted are mounted on a container 5. The container 5 is fitted permanently in the ceiling of the room in which the workplace region is situated, i.e. here in the ceiling 6 of the operating room 7 in which the operating region 2 defining or constituting the operating table 8 is situated.

The container 5 comprises with advantage, or is connected via an air duct 9 to, at least one air intake for taking air in from the room 7 and/or from at least one location outside said room. Thus, for example, some of the air drawn out of the room 7 via air extracts 10 at or near the floor 11 of the room may be led back to the air supply units 3 in the ventilating device. Air may also be brought from air intakes (not depicted) in or near the ceiling 6 of the room 7.

The container 5 comprises with advantage, or is likewise connected via preferably the same air duct 9 to, a fan device (not depicted) for supplying air and causing it to flow through the air supply units 3.

Correspondingly, the container 5 comprises, or is connected preferably via same air duct 9 to, an air treatment device for generating clean air for the clean air zone 1. The air treatment device comprises in a simple version at least one filter device (not depicted) for filtering the air to the air supply units 3 so that the air will be clean and can constitute said clean air zone 1, and also a device (not depicted) for cooling of air from the filter device to a lower temperature than the temperature of the air in the room 7, so that clean air intended to constitute the clean air zone will be at such a lower temperature, e.g. 1-2° C. lower, than air surrounding the clean air zone that clean air in the clean air zone sinks slowly downwards towards the workplace region, here the operating table workplace region 2. The higher density of the cooler air is thus used for controlling the downward velocity. In some embodiments, it may be advantageous to maintain a low velocity, that is, a small air temperature difference between ambient and supply air, for example between 0.3 and 1° C., or between 0.5 and 1° C. Filtered air is typically forced out of the air supply unit with only enough dynamic pressure sufficient to overcome resistance in the air supply nozzle and the rest of the device. This initial velocity is quickly counteracted by the static pressure of ambient air, such that continued downward descent of supply air a few centimeters away from the supply unit is determined by the air temperature difference. The air temperature difference need only be sufficient to provide the velocity required at the workplace region for maintaining a clean air zone. Where the supply air flow is substantially laminar, and in-mixing with ambient air is avoided, the air-temperature difference is maintained throughout the path of descent. Fewer disturbing effects, turbulence, and secondary air flows outside the workplace region are thereby generated, resulting in less risk of contamination of the workplace region. Low air velocity results in small air flow with high efficiency and, for personnel, a draught-free and quiet work environment.

The level of the preferably constant lower temperature of the air in the clean air zone 1 relative to surrounding air in the room 7 is with advantage maintained by a regulating device (not depicted) which forms part of the ventilating device and which therefore regulates the temperature of the clean air in the clean air zone in order to regulate the velocity of the clean air in the clean air zone. To this end, the regulating device is controlled by air temperature sensors of a suitable type. In preferred embodiments, one sensor is situated with advantage in the air flow at the level of the operating table 8 in the operating room 7 while a second sensor is situated outside the air flow at the same level (19).

The air supply units 3 and the air stop and guide units 4 disposed between them are preferably fitted at or in the vicinity of the outer periphery of the container 5 if the shape of the container is different from the closed pattern which said air supply units and air stop and guide units form.

As depicted in FIG. 1, a lighting device with one or more lamps 12 suspended in arms 13 may be situated close to the container 5.

In the depicted preferred version, the container 5 takes the form of a container 14 with the air supply units 3 and the air stop and guide units 4 disposed between them fitted on the underside of the container. The container 14 is here circular with a diameter of about 1 to 4 m. The closed circular pattern of air supply units 3 and air stop and guide units 4 runs along and close to the outer periphery of the container 14.

The respective air supply units 3 in the ventilating device may be of the type described in, for example, PCT/SE2004/001182, which is hereby incorporated by reference herein in entirety. Thus the respective air supply units 3 as seen from the side may preferably be of at least partly hemispherical or substantially hemispherical shape, resulting in a distinct clean air zone with a distinctly limited extent from each air supply unit. The respective air supply units 3 also preferably present a substantially circular cross-section. Each air supply unit 3 has a body 15 made of foam plastic or similar porous material or fabric adapted to generating laminar air flows, thereby minimizing the risk of air surrounding the clean air zone 1 entering the clean air zone. The body 15 may comprise an inner element and an outer element, the inner element imparting to air flowing through a greater pressure drop than the outer element. The inner element may be made of foam plastic or other porous material or fabric, while the outer element takes the form of, for example, tubular throughflow ducts. The length of these throughflow ducts is with advantage 4-10 times greater than their width, to ensure that the turbulence in at least an outer portion of the clean air zone 1 will be as little as possible. Other suitable types of air supply units with desired suitable functions may nevertheless be used in the ventilating device according to the present invention.

The form of the respective air stop and guide units 4 will be appropriate to the desired function. In the version depicted, each air stop and guide unit 4 comprises accordingly at least one air stop surface 16 which faces away from the clean air zone 1 and prevents or hinders air surrounding the clean air zone from being drawn in between adjoining air supply units 3 and into the clean air zone. Each air stop and guide unit 4 also comprises at least two first air guide surfaces 17 which run from the air stop surface 16 in between adjoining air supply units 3, converge towards one another and guide away from one another and out from the centre of the clean air zone 1 parts of the respective air flows directed towards one another from adjoining air supply units. Each air stop and guide unit 4 also comprises at least two second air guide surfaces 18 which face inwards towards the centre of the clean air zone 1 and towards said first air guide surfaces 17, converge towards one another and guide away from one another and inwards towards the centre of the clean air zone parts of the air flows directed towards one another from adjoining air supply units 3. This preferred version of the air stop and guide units 4 achieves the least possible turbulence between the air flows meeting between the air supply units 3 and prevents bacteria-bearing and other pollutant particles from being drawn into the clean air zone 1.

As the respective air supply units 3 in the preferred version depicted are substantially circular in shape, the respective air stop and guide units 4, especially their first air guide surfaces 17, run here along at least about 90″ of the periphery of adjoining air supply units.

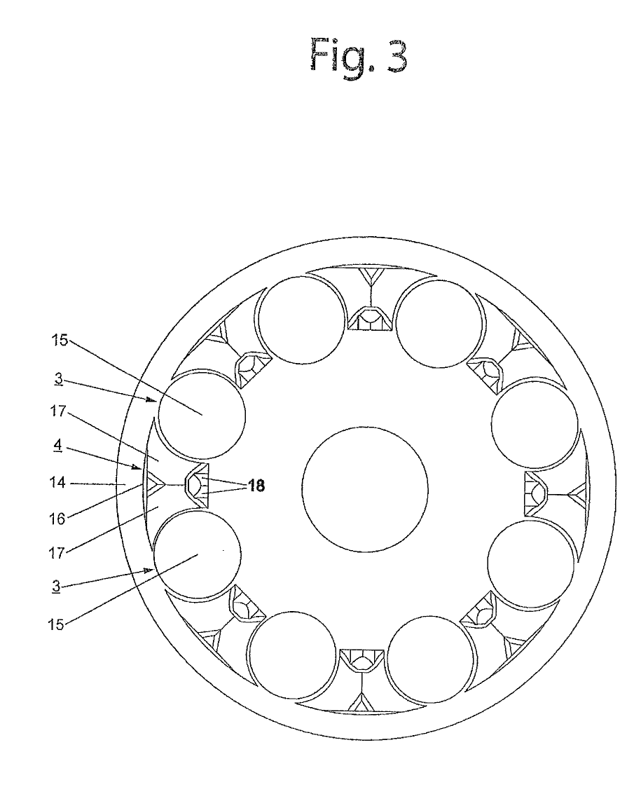

The air stop surface 16 on the air stop and guide units 4 has with advantage a configuration which in at least a cross-sectional plane through said surface and through the air supply units 3 coincides with the configuration of a line which links the outermost portions of the air supply units as seen from the clean air zone 1. As shown in FIG. 3, in the preferred version depicted with the air supply units 3 disposed in a circle, the air stop surface 16 has accordingly a curvature which in said cross-sectional plane coincides with the curvature of a circular line which runs through the radially outermost portions of the air supply units. The air stop surface 16 is also preferably of such a length that it runs from the vicinity of the outermost portions of one of the two mutually adjacent air supply units 3 between which the respective air stop and guide unit 4 is disposed, to the vicinity of the outermost portions of the other of the two air supply units. This contributes to optimum filling of the space between each pair of mutually adjacent air supply units 3.

As shown in FIG. 3, in the preferred version depicted with the air supply units 3 disposed in a circle, the first air guide surfaces 17 on the respective air stop and guide unit 4 as seen in a cross-sectional plane converge towards one another preferably in a manner corresponding to the cross-sectional shape of adjoining air supply units 3, i.e. said surfaces run towards one another inwards towards the centre of the clean air zone 1 and have accordingly the same configuration as adjoining air supply units so that the distance between the first air guide surfaces and the air supply units is constant.

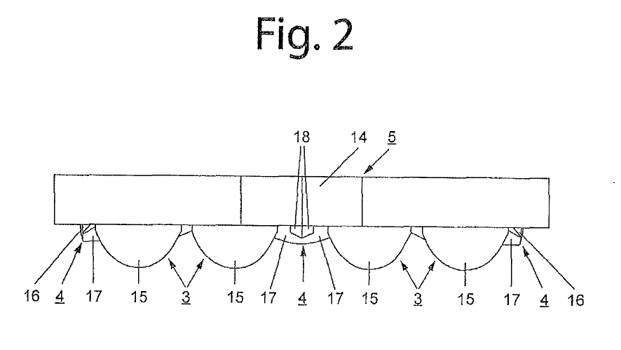

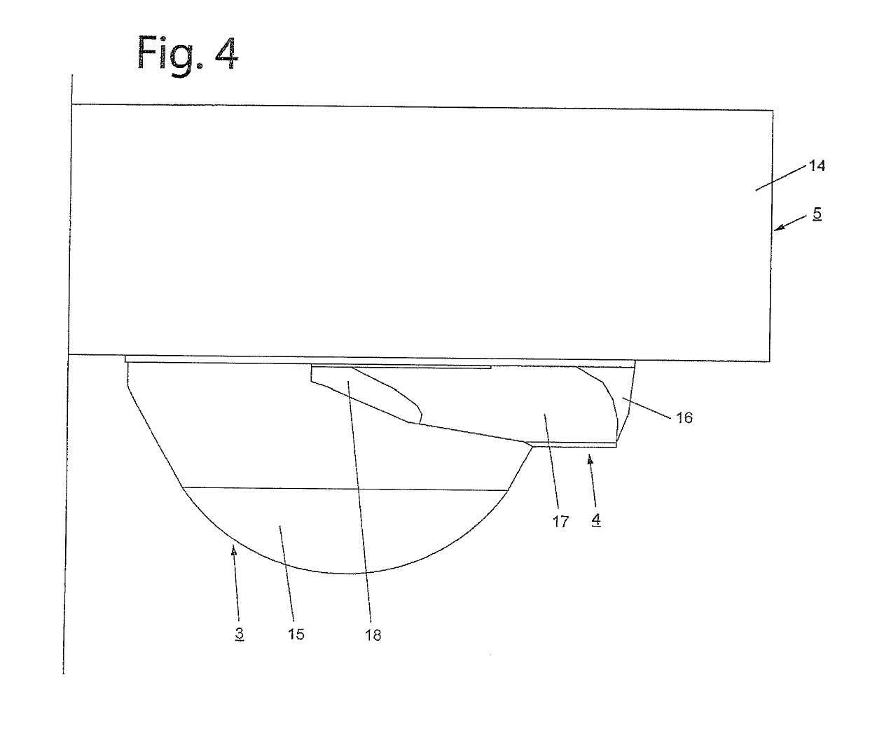

The first air guide surfaces 17 as seen in a longitudinal sectional plane also converge towards one another, i.e. said surfaces run towards one another downwards to the workplace region 2 in the clean air zone 1 (see FIGS. 2 and 4).

Finally, the second air guide surfaces 18 run, as above, towards the first air guide surfaces 17 outwards from the centre of the clean air zone I and downwards towards the workplace region in the clean air zone (see FIGS. 2-4). They also run towards one another downwards towards said workplace region (see FIGS. 2 and 4).

With the object of also controlling the level of bacteria-bearing and other pollutant particles outside the clean air zone the workplace region 2 and preventing or hindering any occurrence of “whirlpools” of secondary air flows holding such particles in suspension, it is advantageous if air is also supplied in a controlled manner outside the clean air zone. To this end, according to the invention, at least one further air supply unit 3, preferably providing a flow of purified air, is disposed in the room 7 to supply air to the room. This air maintains with advantage a temperature exceeding the temperature of the air in the clean air zone 1, thereby compensating in particular for the cooling effect caused by the clean air zone 1. In the preferred version depicted, a plurality of further air supply units 3 are disposed all round the first-mentioned air supply units 3 and said air stop and guide units 4 (on the container 5) in the room 7 to supply the room round the clean air zone with somewhat warmer air than the air in the clean air zone 1. Said further air supply units 3 have their own, or are suitably connected at least to the aforesaid, fan and filter devices.

Accordingly, a method for temperature-regulated laminar air flow ventilation of a surgical theater is also provided. The room air temperature at the level of the operating table is measured by a sensor 19 and the supply air temperature controlled in relation to this measurement, thereby controlling the corresponding velocity of the downward directed laminar air flow at the desired level. In order to maintain a constant downward directed laminar air flow velocity, a constant difference in temperature is maintained between room air temperature at the level of the operating table and the lower temperature of the supply air. In preferred embodiments, this constant temperature difference provides a downward directed air flow velocity of at least 0.25 m/s and is maintained by air supply units supplying heated or cooled air outside the operative area. As used herein, the term “constant” as applied to temperature refers to a level that is within +/−0.5 degree C. The term “constant” as applied to temperature difference refers to a level that is maintained within +/−0.5 degrees C. The term “constant” as applied to room temperature refers to a level that is maintained within +/−1 degree C. The term “constant” as applied to air flow velocity refers to a level that is maintained within +/−40%. In preferred embodiments additional clean air supply devices maintain constant room temperature by introducing warmed or cooled air in a controlled manner. For example, using air supply devices described in PCT/SE2004/001182, 60% of the supply air (providing supply air at a fixed lower air temperature than ambient room air temperature to secure the correct downward directed velocity) can be supplied using ventilation devices of the invention. The additional 40% of supply air can be supplied by external air supply devices (providing supply air at a higher temperature to maintain a required room temperature. 100% of the supply air can be evacuated at floor level. In this manner the entire room will be served by steady downward directed laminar airflows of different velocities. The room temperature can be adjusted to any level required by operative personnel or by a surgical procedure without affecting the temperature difference and thereby the downward directed velocity at the point of surgery.

Ventilating devices according to the invention may further comprise a regulating device (not depicted) for regulating the temperature of the air which is supplied to the room 7 and caused to surround the clean air zone 1, and/or for regulating the velocity of the air which is supplied to the room and is caused to surround the clean air zone. The temperature of the whole room 7 can thereby be regulated. The regulating device is controlled by temperature sensors situated in the room 7 outside the clean air zone 1.

It will be obvious to one skilled in the art that ventilating devices according to the invention can be modified and altered within the scope of the claims set out below without departing from the idea and object of the invention. Thus, for example, said fan, filter and cooling devices may be configured and disposed in any manner appropriate to the purpose, as also may said regulating devices. The number, type and shape of the air supply units and of the air stop and guide units may vary beyond what is indicated above, as also may how they are positioned relative to one another and how they are positioned on the container for the ventilating device. The shape of the container may also vary beyond what is indicated above and may also, as previously indicated, follow or not follow the closed pattern constituted by the air supply units and the air stop and guide units.

1. A method for ventilating a surgical theater comprising
Discharging a purified air stream through an air supply device, situated above the operating table workplace area, as a substantially laminar descending air flow with velocity determined by the difference in air-temperature between the supplied air and the ambient air at the level of the operating table
wherein a constant difference in air-temperature between the supplied air and the ambient air at the level of the operating table is maintained in part by use of air supply units providing heated or cooled air outside the clean air zone surrounding the operating table workplace area.

2. A method for ventilating a surgical theater, comprising
providing a constant downward directed laminar clean air flow velocity over the operating table workplace area by maintaining a constant difference in temperature between the room air temperature at the level of the operating table and the lower temperature of the clean air supplied over the operative area, and
maintaining a constant room air temperature at the level of the operating table by use of air supply units providing heated or cooled air outside the clean air zone surrounding the operating table workplace area.

3. The method of claim 1 in which the downward directed air flow velocity is maintained constant at 0.25 m/s or higher.

4. The method of claim 1 wherein the air temperature difference between clean supply air and room air temperature at the level of the operating table is maintained in the range of about 1 to 2° C.

5. The method of claim 1 wherein the air temperature difference between clean supply air and room air temperature at the level of the operating table is maintained in the range of about 0.3 to 1° C.

6. The method of claim 1 wherein the air temperature difference between clean supply air and room air temperature at the level of the operating table is maintained in the range of about 0.5 to 2° C.

7. The method of claim 1 practiced using a ventilating device for providing in a room a zone of clean air between the ventilating device and a workplace region in the room, which ventilating device comprises air supply units adapted to generating laminar air flows intended to constitute said clean air zone, characterised in that the ventilating device comprises at least three air supply units disposed in a closed pattern so that the extent in cross-section of the clean air zone below the air supply units substantially corresponds to the surface delineated by said closed pattern of air supply units and the surface situated within that pattern, and a corresponding number of air stop and guide units disposed between, and substantially filling the space between, each pair of mutually adjacent air supply units, each air stop and guide unit having at least one air stop surface which faces outwards away from the clean air zone and prevents or hinders air surrounding the clean air zone from being drawn in between adjoining air supply units and into the clean air zone, at least two first air guide surfaces which run from the air stop surface in between adjoining air supply units, converge towards one another and guide parts of the air flows from adjoining air supply units that are directed towards one another away from one another and outwards from the centre of the clean air zone, and at least two second air guide surfaces which face inwards towards the centre of the clean air zone and converge towards said first air guide surfaces and towards one another and guide other parts of the air flows from adjoining air supply units that are directed towards one another away from one another and inwards towards the centre of the clean air zone.

8. The method of claim 2 in which the downward directed air flow velocity is maintained constant at 0.25 m/s or higher.

9. The method of claim 2 wherein the air temperature difference between clean supply air and room air temperature at the level of the operating table is maintained in the range of about 1 to 2° C.

10. The method of claim 2 wherein the air temperature difference between clean supply air and room air temperature at the level of the operating table is maintained in the range of about 0.3 to 1° C.

11. The method of claim 2 wherein the air temperature difference between clean supply air and room air temperature at the level of the operating table is maintained in the range of about 0.5 to 2° C.

12. The method of claim 2 practiced using a ventilating device for providing in a room a zone of clean air between the ventilating device and a workplace region in the room, which ventilating device comprises air supply units adapted to generating laminar air flows intended to constitute said clean air zone, characterised in that the ventilating device comprises at least three air supply units disposed in a closed pattern so that the extent in cross-section of the clean air zone below the air supply units substantially corresponds to the surface delineated by said closed pattern of air supply units and the surface situated within that pattern, and a corresponding number of air stop and guide units disposed between, and substantially filling the space between, each pair of mutually adjacent air supply units, each air stop and guide unit having at least one air stop surface which faces outwards away from the clean air zone and prevents or hinders air surrounding the clean air zone from being drawn in between adjoining air supply units and into the clean air zone, at least two first air guide surfaces which run from the air stop surface in between adjoining air supply units, converge towards one another and guide parts of the air flows from adjoining air supply units that are directed towards one another away from one another and outwards from the centre of the clean air zone, and at least two second air guide surfaces which face inwards towards the centre of the clean air zone and converge towards said first air guide surfaces and towards one another and guide other parts of the air flows from adjoining air supply units that are directed towards one another away from one another and inwards towards the centre of the clean air zone.
